(19) United States
(12) Patent Application Publication
(10) Pub. No.: US 2016/0098687 A1
(43) Pub. Date: Apr. 7, 2016

(54) SYSTEMS AND METHODS FOR PRIVATE SCHEDULE COORDINATION AND EVENT PLANNING

(71) Applicant: Skejul Inc., St. Louis, MO (US)

(72) Inventors: Matthew Lamons, Millstadt, IL (US); Paul Heirendt, St. Louis, MO (US); Matthew Kulig, Millstadt, IL (US); Mark Lamons, Lakeland, FL (US)

(21) Appl. No.: 14/941,142

(22) Filed: Nov. 13, 2015

Related U.S. Application Data
(63) Continuation of application No. PCT/US15/53966, filed on Oct. 5, 2015.
(60) Provisional application No. 62/059,508, filed on Oct. 3, 2014.

(51) Int. Cl. G06Q 10/10

(52) U.S. Cl. CPC G06Q 10/1095

(57) ABSTRACT

Systems and methods for scheduling events for one or more users using a decision engine examining data in user models to select a date, time, and/or place to schedule a meeting between the users and store the meeting data in an event cloud using a dynamic software object.

### CROSS-REFERENCE TO RELATED APPLICATIONS

This application is a Continuation of PCT Application Serial No. PCT/US2015/053966, filed on Oct. 5, 2015, which in turns claims priority to U.S. Utility application Ser. No. 14/874,113 and benefit of U.S. Provisional Patent Application No. 62/059,508, filed Oct. 3, 2014. The entire disclosure of all of these documents are incorporated herein by reference.

### BACKGROUND

1. Field of the Invention

This disclosure is related to the field of scheduling and planning, and particularly to computer-aided predictive scheduling and planning for meetings, conferences, events, appointments, social gatherings, and other shared activities.

2. Description of the Related Art

Scheduling is a group decision making problem. Even with the prevalence of modern event planning and scheduling software, it remains difficult to coordinate multiple people to schedule everyday events. This problem is not confined to business users, as families are increasingly busy, with parents and children alike having multiple events scheduled at multiple locations throughout the week.

The difficulty in scheduling events stems from a number of problems, such as discovering availability and preferences, matching these among a group of invitees, communicating the solution, and communicating it to those who need to know (which may include individuals beyond the invitee, such as venue managers, secretaries, assistants, family members, etc.).

Discovering availability and preferences is difficult because it requires the discovery and application of data that is not (and in most cases, should not be) shared among all invitees, and it also requires the discovery of information that does not exist in a calendar, and may not exist anywhere other than in the minds of the invitees. Prior to the computerization of calendar data, this exercise involved a number of people looking at paper calendars and essentially performing an “overlap” whereby the invitees to a meeting would attempt to identify a date when each invitee is not only available, but able to arrive at the meeting location on time, and get to his or her next scheduled appointment on time. This obviously requires a consideration not only of when people are available, but where they are available. The “where” portion of this formula is made even more difficult by the fact that travel times to and from locations can change dramatically from day to day depending upon changing circumstances that cannot be definitively known in advance, such as traffic and weather.

Computer solutions solve only part of this problem. Products such as Microsoft® Outlook® and Google® Calendar provide electronic interfaces into calendaring and appointment data and can provide features such as reminders and overlap warnings when a user attempts to double-book himself, but coordinating with others remains a problem. For one, where users are not within the same enterprise, sharing calendar data is often difficult or impossible due to both technological and business limitations. Different calendaring systems may be incompatible or fail to communicate to synchronize with each other, or the business or legal rules governing an enterprise may prohibit public sharing of calendaring data outside the company.

Moreover, technological solutions still involve the same basic problems as paper solutions. Typically, the individual setting the appointment, referred to herein as the inviting user, sends an e-mail or other electronic invitation to the invitees, suggesting a date, time, and place. The invitee users then consult their calendars and accept or reject (or not respond at all) depending upon their availability. They may also suggest alternatives. This may result in a flurry of e-mails each containing a variety of suggested alternative dates, times, and places. Often, the inviting user gathers the response data from the other users, filters through it, and identifies a common date, time or place when all are available. If there is no such date, time or place, the inviting user may request additional dates, times and places, or may provide his own alternative dates, times and places, and throw the question back to the group as to when and where to meet.

These polling/voting approaches suffer a number of deficiencies. Apart from being inefficient and timewasting, it is impractical (and sometimes impossible) to schedule in this fashion for a large group of people. Further, this system also conflates availability with preference. One user may, technically speaking, be available at a particular time but not offer it because the user would prefer not to meet then. Thus, a possible meeting date, which is convenient for all but one invitee, is overlooked, forcing everybody else to schedule at a different time, which may be equally inconvenient for one or more other people.

For any non-trivial group of people, the computational effort required to solve this problem is far beyond the practical capacity of any one person, and with sufficiently large groups, is beyond human capability.

Another problem is that with large groups of people, there often is no clear leadership driving the process. For example, where numerous professionals are attempting to coordinate an event, courtesy dictates that no one person insist upon a given time or date, but rather that all come to uniform and amicable agreement on when and where to meet. Unless one person takes charge and drives the process and continually follows up, the meeting is often not scheduled for days, weeks or even months.

This also presents the problem of imbalanced scheduling. In the previous example one user did not offer dates when he was available because it is inconvenient, but another offered all available dates whether convenient or not, in hopes of getting the meeting scheduled. Over time, this can result in disproportionate inconvenience and hassle to the most cooperative participants, particularly for regular meetings, as users who tend to offer all dates in the interest of cooperation will continually be inconvenienced in favor of users who conflate unavailability with inconvenient availability. This results in a disparity in fairness, and biases meeting times and places in favor of one or two persons at the expense of others, simply because different users perceive and report availability on two different sets of criteria.

Another problem, particularly in arm's-length transactions involving professionals and businesses, is that the participants do not wish to share their calendar data at all, or share as little as possible, and thus do not want to disseminate lists of available and unavailable times. This is particularly acute where the parties to a meeting may be adverse in some fashion or lack equal bargaining position, such as attorneys or business contacts negotiating a deal, or parties with a disparity in social standing, influence, or wealth. In other cases, users may simply desire to keep their personal schedules private from one another for their own individual reasons. For example, when scheduling activities with children, parents may prefer that strangers not know the parents' or children's schedules any more than is absolutely necessary. The more the back-and-forth exchange of invitations and dates and times goes on, the more information about each participant's availability is revealed.

If a business discloses all availability, business rules cannot be applied to incoming appointment requests to optimize operations for profit and throughput. This results in lost efficiency, which imposes a real business cost, as each block of time has equal weight/importance and any could be selected.

Yet another problem is that these types of negotiations require each user to independently determine travel times and take account of factors which may not be known in advance, or which may be difficult to calculate. For example, where the meeting is to take place at a particular location, some users may be able to get there quickly because they work or live nearby, and others may not. When the date, time and place is suggested, each user must not only check his or her calendar, but must also identify the location of any meetings adjacent to the proposed time, and calculate the user's travel time from the prior meeting to the next. This adds an additional level of complexity, as, while it is easy for most users to quickly glance at a digital calendar display, such as Microsoft® Outlook®, to determine availability, it requires at least one additional step for the user to determine travel time, assuming that doing so is possible at all.

Scheduling large numbers of people is orders of magnitude more difficult, such as where an event is planned with dozens, hundreds or even thousands of invitees. At that scale, it is virtually impossible to coordinate and collaborate with all invitees, as it is very unlikely that there is any date when all potential invitees would be available—indeed, the list of invitees may not even be fully known when the event is planned. Instead, event planners generally consider the type and nature of the event and anticipated invitees and try to schedule around other events that would likely be of interest to those invitees and could produce a conflict. They may also use year-over-year comparisons to gain a modest degree of intelligence on probability of attendance, but this is mere guesswork based on the past.

For example, when scheduling an evening performance for a middle school play, the school staff is likely to consider that the parents have other children in school in other grades, who may have conflicts. Since the school is a middle school, it is likely that there are a large number of parents who have high school age children and/or grade school age children. Therefore, the staff tends to schedule away from Friday evenings in fall because the local high school almost certainly will have a football game most Fridays in the fall, presenting a conflict. This is a coarse proxy for the individuals' preferences or availabilities and is prone to error, which can result in serious scheduling conflicts simply because the event planners overlooked competing events. This happens not only with school scheduling, but with social clubs, trade associations, professional groups, and virtually any other association or organization of people sharing a common interest or characteristic. All it takes is for the event planners to miss one conflict, and they will have scheduled an event which is virtually impossible for its most interested invitees to attend.

Another pitfall with event planning is that during the pendency of scheduling negotiations, while everybody is trying to determine a mutually agreeable date, additional invitations are typically coming to each individual participant. Thus, one person may provide his or her availability, only to later have another meeting invite conflict with one of previously provided available dates. That person must then either update the first group that one of the dates which she had previously indicated as available is no longer available, or push back on the second meeting invite on grounds that there may be a conflict. This may cause the user to reschedule the second meeting around the availability she previously provided, or push it off entirely, in order to preserve an availability date which may not ultimately be used.

Thus, users may wind up rescheduling events unnecessarily to avoid the appearance of being difficult or uncooperative. To get around this, users sometimes block out large chunks of time on their digital calendars to reflect availability dates they have previously offered up. However, this again simply shifts the problem rather than solving it. With large chunks of time blocked out, when new meeting invites come up, the user may have multiple days the user has previously reserved for still-pending meeting, and which are not available for the next meeting, forcing the second meeting to be scheduled around the user's proposed availability for the first one. Further, data awareness is a problem with time blocking, as the user often has a hard time remembering which blocks are legitimate obligations and which blocks are placeholders.

Sometimes, a meeting is scheduled over a conflict when a particular person did not provide their availability correctly or overlooked a time or day when he or she could not meet when providing availability. This can then require the event to be rescheduled, starting the process all over again. This time delay problem also applies to resources, as a conference room or other meeting location or resource may need to be reserved or booked. It often happens that when the meeting is first proposed, a given meeting space is available, but by the time the meeting time and date is finalized, the space has been taken. The event organizers may be reluctant to put down a deposit to reserve a space until they are sure the space will be filled and needed, as deposits are sometimes non-refundable for this exact reason. Thus, the delay in putting down the deposit can cause a resource (e.g., venue or location) not to be initially reserved and then subsequently be booked, forcing the scheduling process to begin anew with a new location.

Further, if the venue is reserved, then, again, the resource is tied up unnecessarily, sometimes for days or weeks, while the organizers wait for all invitees to provide their acceptance of the invitation. This can force other meetings or conferences or appointments to be scheduled around the blocked time for the reserved venue, which may not ultimately be used at all at the proposed time.

Much of the difficulty with scheduling stems from the fact that it cannot be done simultaneously and in real time, and requires the activate participation of all invitees. This means that if one invitee is unavailable (e.g., on an airplane flight, on a vacation in a remote area, or otherwise indisposed), the entire process stalls until that person is available. Also, if a particular invitee is simply dilatory in responding for any reason, such as that the invitee is adverse to the rest and doesn't wish to meet at all, the scheduling process fails. This results in wasted time, frustration, annoyance, and confusion. What is needed is a computerized system for coordinating and scheduling appointments, events, meetings, and conferences in real time for all participants, taking due regard of the location of the participants before, after and during the meeting.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for privately scheduling a meeting between two users at a mutually available time without the use of a human intermediary and without specifying a candidate time for such meeting, the method comprising: providing a scheduling server communicating over a network with an inviting user calendar system and an invitee user calendar system; the scheduling server receiving an invitation to a meeting between an inviting user and an invitee user, wherein the invitation does not include a candidate time for the meeting; the scheduling server transmitting to the inviting user calendar system a request for calendar data for the inviting user; the scheduling server transmitting to the invitee user calendar system a request for calendar data for the invitee user; the scheduling server receiving from the inviting user calendar system calendar data for the inviting user; the scheduling server receiving from the invitee user calendar system calendar data for the invitee user; the scheduling server selecting the candidate time for the meeting as a time the inviting user is available for the meeting as indicated in the received inviting user calendar data, and as a time the invitee user is available for the meeting as indicated in the received invitee user calendar data; the scheduling server causing to be scheduled in the inviting user calendar system a meeting between the invitee user and the inviting user at the candidate time; and the scheduling server causing to be scheduled in the invitee user calendar system a meeting between the invitee user and the inviting user at the candidate time.

In an embodiment, the candidate time comprises a date and time of day.

In an embodiment, in the selecting, the scheduling server chooses a plurality of candidate times for the meeting, each candidate time in the plurality of candidate times being chosen because the inviting user is available for the meeting as indicated in the received inviting user calendar data, and the invitee user is available for the meeting as indicated in the received invitee user calendar data at the candidate time; and wherein, in the causing to be scheduled in the invitee user calendar system; the scheduling server transmits to the invitee user an invitation to the meeting, the transmitted invitation including each candidate time in the plurality of candidate times; the scheduling server receives from the invitee user an acceptance of the transmitted invitation, the received acceptance indicating a candidate time in the plurality of transmitted candidate times accepted by the invitee user;

In a further embodiment, the received acceptance further indicates a preferred accepted candidate time and a non-preferred accepted candidate time; the scheduling server causing to be scheduled in the inviting user calendar system a meeting between the invitee user and the inviting user at the preferred accepted candidate time; and the scheduling server causing to be scheduled in the invitee user calendar system a meeting between the invitee user and the inviting user at the preferred candidate time.

In a still further embodiment, at least one of the candidate times is selected based in part on, in a prior use of the method in which the inviting user was an invitee user, which candidate time in the prior use of the method the inviting user accepted.

In a still further embodiment, at least one of the candidate times is selected based in part on, in a prior use of the method in which the inviting user was an invitee user, which candidate time in the prior use of the method the inviting user accepted as a preferred accepted candidate time.

In a still further embodiment, at least one of the candidate times is selected based in part on, in a prior use of the method in which the inviting user was an invitee user, which candidate time in the prior use of the method the inviting user accepted as a non-preferred accepted candidate time.

In a still further embodiment, the method further comprises: the selecting step further comprising selecting a meeting location, the meeting location being selected based in part upon the proximity of other appointments to the meeting location for the inviting user in the inviting user calendar data, and based at least in part upon the proximity of other appointments to the meeting location for the invitee user in the invitee user calendar data; the scheduling server causing to be scheduled in the inviting user calendar system a meeting between the invitee user and the inviting user at the selected location; and the scheduling server causing to be scheduled in the invitee user calendar system a meeting between the invitee user and the inviting user at the selected location.

In a still further embodiment, the location and the candidate time are selected in part by calculating an estimated amount of time for the inviting user to travel to the location from the location of an appointment indicated in the inviting user calendar data as occurring prior to the candidate time.

In a still further embodiment, the location and the candidate time are selected in part by calculating an estimated amount of time for the inviting user to travel from the location to the location of an appointment indicated in the inviting user calendar data as occurring subsequent to the candidate time.

In a still further embodiment, the scheduling server receives the invitation from a user device of the inviting user.

In a still further embodiment, the user device is selected from a group consisting of a mobile phone, a smart phone, a desktop computer, a laptop computer, a tablet computer, and a wearable computer.

In a still further embodiment, the inviting user calendar system and the invitee user calendar system do not directly communicate with each other over the network.

Also described herein, among other things, is a method for scheduling a meeting between two users at a mutually available time based upon the availability of a group associated with at least one such user comprising: providing a scheduling server communicating over a network with an inviting user calendar system and an invitee user calendar system; the scheduling server receiving a first invitation to a first meeting between a first inviting user and a plurality of invitee users, each of the invitee users having calendar data; the scheduling server associating the first inviting user and each invitee user in the plurality of invitee users in a user pool; the scheduling server receiving a second invitation to a second meeting between a second inviting user and a second invitee user, the second invitee user being a user associated in the user pool in the associating step; the scheduling server selecting a candidate time for the second meeting as a time each user in the user pool is available for the second meeting as indicated in the calendar data for the each user; the scheduling server scheduling the second meeting at the candidate time in the calendar data for the second invitee user.

In an embodiment, the method further comprises: providing user pool calendar data comprising a plurality of scheduled events; the scheduling server associating the user pool with the calendar data; wherein the candidate time is selected as a time indicated in the user pool calendar data as having none of the plurality of scheduled events scheduled.

In a further embodiment, the second inviting user is not a user in the user pool.

Also described herein, among other things, is a non-transitory computer-readable medium for privately scheduling a meeting between two users at a mutually available time without the use of a human intermediary and without specifying a candidate time for such meeting protecting, the medium comprising: computer-readable instructions for receiving an invitation to a meeting between an inviting user and an invitee user, wherein the invitation does not include a candidate time for the meeting; computer-readable instructions for transmitting to the inviting user calendar system a request for calendar data for the inviting user; computer-readable instructions for transmitting to the invitee user calendar system a request for calendar data for the invitee user; computer-readable instructions for receiving from the inviting user calendar system calendar data for the inviting user; computer-readable instructions for receiving from the invitee user calendar system calendar data for the invitee user; computer-readable instructions for selecting the candidate time for the meeting as a time the inviting user is available for the meeting as indicated in the received inviting user calendar data, and as a time the invitee user is available for the meeting as indicated in the received invitee user calendar data; computer-readable instructions for causing to be scheduled in the inviting user calendar system a meeting between the invitee user and the inviting user at the candidate time; and computer-readable instructions for causing to be scheduled in the invitee user calendar system a meeting between the invitee user and the inviting user at the candidate time.

In an embodiment, the candidate time comprises a date and time of day.

In an embodiment, the medium further comprises: computer-readable instructions for selecting a plurality of candidate times for the meeting, each candidate time in the plurality of candidate times being selected as a time the inviting user is available for the meeting as indicated in the received inviting user calendar data, and as a time the invitee user is available for the meeting as indicated in the received invitee user calendar data; computer-readable instructions for transmitting to the invitee user an invitation to the meeting, the transmitted invitation including each candidate time in the plurality of candidate times; computer-readable instructions for receiving from the invitee user an acceptance of the transmitted invitation, the received acceptance indicating a candidate time in the plurality of transmitted candidate times accepted by the invitee user; computer-readable instructions for causing to be scheduled in the inviting user calendar system a meeting between the invitee user and the inviting user at the accepted candidate time; and computer-readable instructions for causing to be scheduled in the invitee user calendar system a meeting between the invitee user and the inviting user at the accepted candidate time.

In a further embodiment, the received acceptance further indicates at a preferred accepted candidate time and a non-preferred accepted candidate time in; and the medium further comprises: computer-readable instructions for causing to be scheduled in the inviting user calendar system a meeting between the invitee user and the inviting user at the preferred accepted candidate time; and computer-readable instructions for causing to be scheduled in the invitee user calendar system a meeting between the invitee user and the inviting user at the preferred candidate time.

### BRIEF DESCRIPTION OF THE DRAWINGS

FIG. 1 depicts a schematic of an embodiment of a system for privately scheduling an event.

FIG. 2 depicts a timeline of an embodiment of a system and method for anonymously scheduling an event.

FIG. 3 depicts an embodiment of an implementation using a customized dynamic object as a view into one or more resources for a candidate meeting.

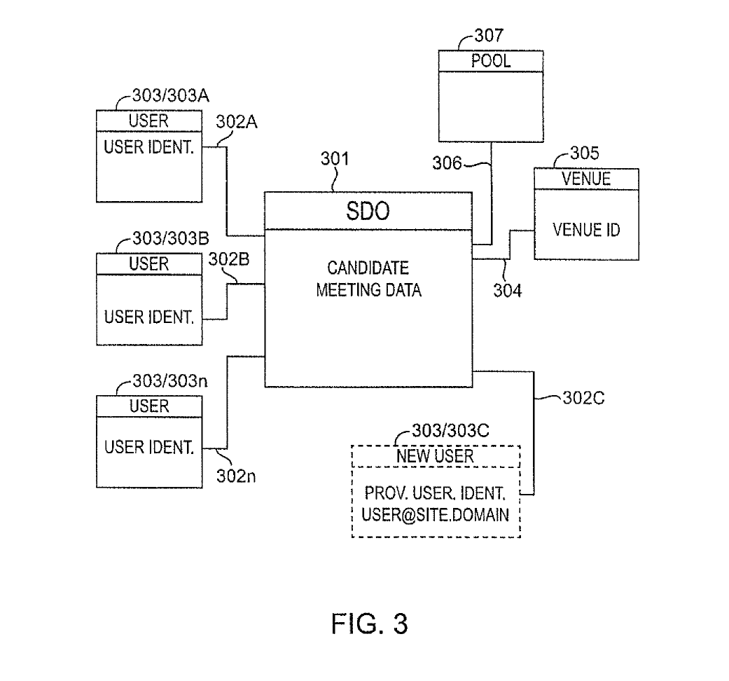

FIG. 4 depicts an embodiment of a system architecture for implementing the systems and methods described herein.

FIG. 5 depicts an embodiment of an event cloud interface using both third party calendaring systems and cloud scheduling systems.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

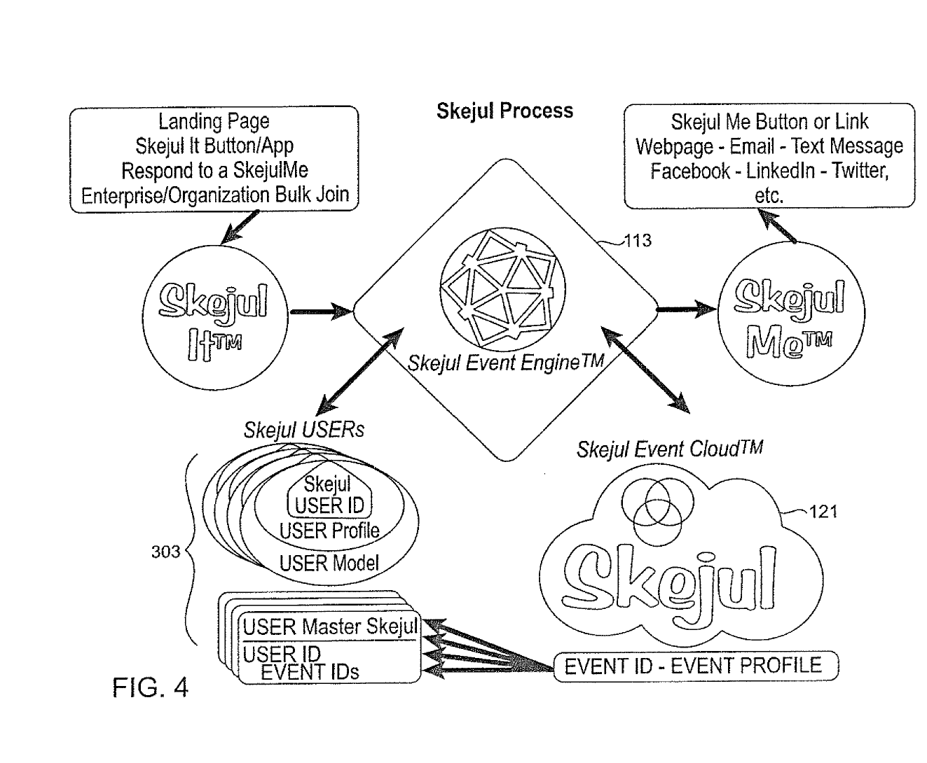

Generally speaking, described herein (among other things) are systems and methods for scheduling events for one or more users. A basic overview is depicted in FIG. 4. The systems and methods generally comprise a decision engine (119) examining data in user models (303) to pick a date, time, and/or place to schedule a meeting between the users and store the meeting data in an event cloud (121) using a special type of software object, referred to as a Skejul™ Dynamic Object herein, or SDO.

Throughout this disclosure, the term “computer” generally refers to hardware which generally implements functionality provided by digital computing technology, particularly computing functionality associated with processors and microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, e-readers, wearable computers including but not limited to Google® Glass™, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to, network hardware, print servers, file servers, NAS and SAN, load balancers, and any other hardware capable of interacting with the systems and methods described herein in the matter of a conventional “computer.”

Throughout this disclosure, the term “software” generally refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including, without limitation, virtual processors, or by the use of run-time environments or virtual machines. Those of ordinary skill in the art recognize that software can be wired directly onto hardware, including, without limitation, onto a microchip, and still be considered “software” within the meaning of this disclosure. For purposes of this disclosure, software includes, without limitation, instructions stored or storable in any form of memory device, including RAM, ROM, flash memory, BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described herein are contemplated to use computers and computer software typically stored in a non-transitory computer- or machine-readable media or memory.

Throughout this disclosure, terms used herein to describe or reference media, including, without limitation, terms such as “media,” “storage media,” and “memory,” generally refer to non-transitory computer-readable media, but may also include transitory media such as signals and carrier waves.

Throughout this disclosure, the term “network” generally refers to any data or telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network, or may, in verb form, refer to a server providing a service over a network, or an access point for a service over a network.

Throughout this disclosure, the terms “web,” “web site,” “web server,” “web client,” and “web browser” generally refer to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). The term “web server” generally refers to a computer receiving and responding to HTTP requests, and a “web client” generally refers to a computer having a user agent sending and receiving responses to HTTP requests. The user agent is generally web browser software.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices.

Throughout this disclosure, the terms “meeting,” “appointment,” “event,” and the like generally refer to a pre-arranged gathering, usually (but not necessarily) of at least two people at a predetermined time and/or place, often for a predetermined duration and/or purpose. These terms will be understood to include both informal and formal gatherings of any size, ranging from a short meeting between two people lasting only moments to an annual week-long conference attended by thousands. While it is generally contemplated that two or more attendees will participate, the systems and methods may be used herein by a single user. For example, a user may schedule a time to drop a package off at the post office and use the systems and methods described herein to identify optimal dates and/or times.

Throughout this disclosure, terms such as “calendar,” “calendar data,” “calendar system,” and the like, generally refer to electronically or digitally stored data pertaining to a user's schedule, appointments, and meetings, typically accessible through a graphical user interface using a computer, such as Microsoft® Outlook® or Google® Calendar. Calendar data in these and other systems is generally accessible through an application programming interface (“API”). The process of a user making available, or granting access to, such data for a third party software program (such as that described here), is often referred to in shorthand as “sharing” a calendar or calendar data. One of ordinary skill in the art will understand that a “calendar system” is generally a calendar and scheduling platform or application suite, which generally includes on-line components and interoperability features, and that “calendar data” is some or all of the data stored or managed in such a calendar system for a particular user or set of users. While calendars are typically associated with human users, they may in certain embodiments be associated with non-human resources. For example, a calendar could be kept and maintained for a venue (e.g., a conference room, hotel room, park shelter, etc.), rental equipment (e.g., cars, machinery), office equipment (e.g., overhead projectors), health care equipment (e.g., computers-on-wheels, radiology equipment), and other resources which may be reserved or scheduled for shared use.

Throughout this disclosure, the teem “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which are manipulable by the user through an input device to provide user input, and which may also display or present to the user information, data, or output.

Throughout this disclosure, references are made to the sending/transmitting and/or receiving of data between computers or computing devices. It will be understood by one of ordinary skill in the art that a description of transferring data between computers shall mean that data and/or one or more datagrams indicative of the information to be transferred are exchanged through known protocols. By way of example and not limitation, a description of an “invitation” being “sent” will be understood to mean that the sending device packages data sufficient to describe the data structure and information for a logical “invitation” into a format for transmission, using known (or in the future developed) protocols, to the receiving machine, where the data is unpackaged into an appropriate format for the receiving machine.

Throughout this disclosure, the term “model” generally refers to a collection of data and/or interfaces to data modeling a particular real-world object or construct, such as a user, a venue, a pool, and so forth. A data model can be roughly thought of as an object in the object-oriented programming sense, but it should be further understood that the data models described herein may include or incorporate data from a wide variety of sources, including user-supplied data, system-supplied data, inferred or derived data from data mining, associations and analytics, and third party data gleaned from external systems. Thus, a data model as used herein is more than a class definition, but rather indicates a complex collection of generally (but not necessarily) interrelated data. By way of example and not limitation, a “user model” comprises a “user profile” (generally user-supplied data such as name, address, phone number) as well as user behavioral data derived over time.

The definitions provided herein should not be understood as limiting, but rather as examples of what certain terms used herein may mean to a person having ordinary skill in the applicable art. A person of ordinary skill in the art may interpret these terms as inherently encompassing and disclosing additional and further meaning not expressly set forth herein. For example, specific platforms now existing, or later developed, such as Android, iOS, Windows, Mac OS, Kindle, and so forth, are all contemplated herein.

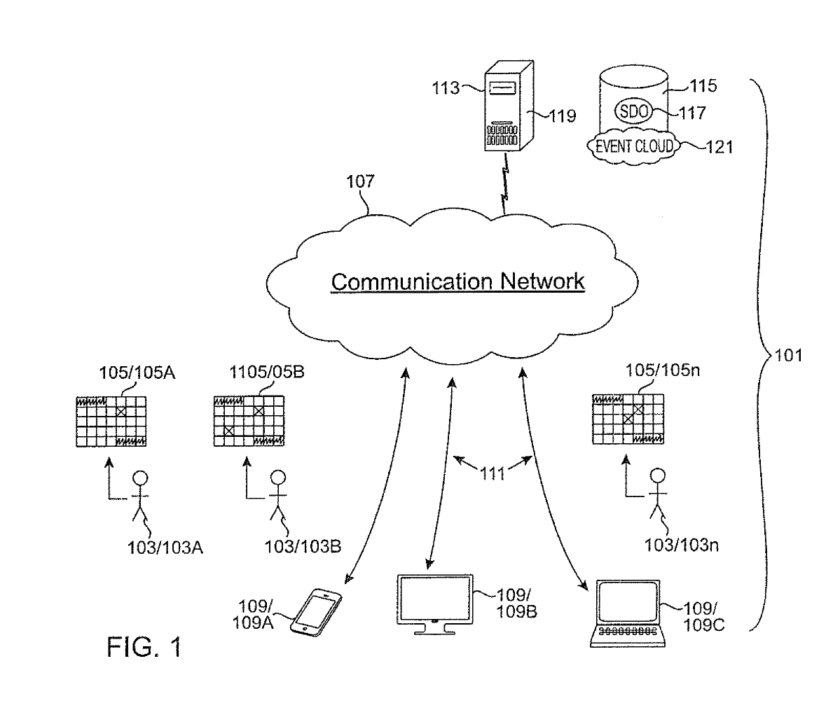

FIG. 1 depicts an embodiment of the systems and methods at a high level of abstraction. In the depicted embodiment of FIG. 1, the system (101) comprises at least one user (103A) who may have at least one associated calendar (105A) using a computer (109A) to communicate with a server (113) over a communication network (107) to schedule at least one event. While there are embodiments in which a single user (103A) will schedule an event that does not require any other users, the more typical case is that a plurality of users (103A, 103B . . . 103n) will collaborate to schedule events. FIG. 1 will be described with reference to a user case in which all users (103A, 103B) to (103n) are registered users of the scheduling system described herein, and have shared or otherwise made available to the scheduling system each user's (103A, 103B . . . 103n) respective calendar (105A, 105B . . . 105n).

Other use cases are specifically contemplated. The above (and typical) case is that a user is registered to use the system and has shared calendar data (typically from a third party calendaring service as described herein, such as Outlook® or Google® Calendar). In such cases, the user generally has a user model in data storage connected to one or more Skejul™ Dynamic Objects as described elsewhere herein. A second use case is where a user is not registered to use the system and/or has not shared calendar data, but has been an invitee user to at least one event scheduled using the system. In such cases, the user also generally has a user model in data storage connected to one or more Skejul™ Dynamic Objects as described elsewhere herein. A third use case is where a user is not registered to use the system and/or has not shared calendar data, and has not previously been an invitee user to any event scheduled using the system. In such cases, new user data and a new user model is created for the user. Other use cases are possible and contemplated, but for purposes of implementation, in any cases, the system preferably has, or upon discovery of a new user creates, a user model for the user based on whatever user identifying information is available, preferably an e-mail address or telephone mobile, particularly a mobile telephone number or other text-enabled or push-messaging enabled mode of direct communication.

At a high level of abstraction, the system works by one user (103A) inviting one or more other users (103B) to (103n) to schedule an event together. The user (103A) initiating the scheduling is generally described herein as the “inviting user” and the other users are generally referred to as the “invitee user(s),” though once the system is set in motion, all users are effectively “invitee users.” Inviting user (103A) generally uses a GUI to indicate the invitee users (103B . . . 103n) with whom invitee user (103A) wishes to meet.

Unlike conventional technology, the inviting user (103A) need not provide or suggest a time, date, location, or any other information pertaining to the logistics of scheduling the event. Rather, inviting user (103A) identifies the invitee users (103B) to (103n) with whom inviting user (103A) would like to meet. Also unlike conventional technology, the invitee users (103B) to (103n) generally do not receive an invitation directly from the inviting user (103A). Rather, as described below, invitee users (103B) to (103n) receive an invitation from a scheduling server (119) suggesting one or more times, dates, and/or places.

In the depicted embodiment of FIG. 1, when inviting user (103A) selects invitee users (103B) to (103n) and begins the scheduling process, a decision engine (113) (i.e., software program or set of programs) on the server (119) uses various algorithms to determine a suggested or proposed time, date, and/or location for the meeting. This determination is described in more detail elsewhere herein, and generally is based on, among other things, one or more factors including but not limited to: user-defined preferences; learned, observed or derived preferences; user availability data; calendar data; past user behavior; pool or group membership; and, other factors as described herein.

It should be noted that, at this point, the decision engine has determined a date/time/location for the meeting, but that date/time/location has not yet been agreed to by users (103). Generally, such a date/time/location for the meeting is referred to as a “candidate meeting” or “candidate date.” For sake of brevity and simplicity, the term “candidate date” should be understood to include a time and, if and as appropriate in a particular embodiment or case, a venue or location.

In the depicted embodiment, the scheduling server (113) then sends to each user (103), including inviting user (103A) and invitee users (103B) to (103n), an invitation to the candidate meeting. Again, unlike conventional technology, the date, time, and/or place for the candidate meeting is not determined by any one individual user (103), but rather by the decision engine (113). Each user (103) may accept or decline the invitation. In the typical case, the invitation will be, at a minimum, for a time, place, and/or location for which calendar data (105) for each of the users (103) indicates that the user (103) associated with that calendar (105) is not already scheduled. If each of the users (103) accepts the invitation, the server (119) will schedule (or cause to be scheduled) the event on each user's (103) associated calendar (105). As described elsewhere herein, this includes the master calendar data in the event cloud (121), and may also include updates for a third party calendaring system. This is generally done using known methods, such as API calls to the calendar or, where the user does not maintain a separate calendar (105), the server (113) will schedule the event internally for the user (103). It should be noted that, in an embodiment, the organizer (inviting user) may be omitted from the acceptance element. For example, the organizer may be presumed to accept the invitation, and reflected in the database as having accepted the date, time, and/or place for the event automatically.

In the depicted embodiment of FIG. 1, if at least one user (103) declines the invitation, the system may do at least one of: retract the invitation as to all users (103), determine a second candidate meeting, or send a second invitation to users (103) for the second candidate meeting. In an alternative embodiment, when an invitee user (103B) to (103n) declines, the inviting user (103A) has the option of either scheduling the candidate meeting with the invitee users (103B) to (103n) who accepted (and thus accepting that the declining users will not attend), or requesting a second candidate meeting. In the latter case, at least one of the steps described above in this paragraph may then be carried out.

In a still further embodiment, the decision engine (113) may determine a plurality of candidate meetings (e.g., a first candidate meeting, a second candidate meeting, etc.), and provide users (103) an invitation to all such candidate meetings in a single invitation. In one such embodiment, each user (103) may select one and only one candidate meeting to attend. If all users select the same candidate meeting, then the meeting is scheduled as described elsewhere herein. In an alternative embodiment, the candidate meeting accepted by the largest number of users (103) is scheduled. In another alternative embodiment, each user (103) may select a plurality of candidate meetings, and the candidate meeting for which all (or, alternatively, the largest number) of users are available is scheduled.

In an embodiment, one or more invitees may be mandatory. In such an embodiment, if a mandatory invitee user declines an invitation, the meeting cannot be scheduled even if all other users are available. In such cases, the decision engine (119) may tend to prefer dates, times, and places, which ensure that mandatory users are available and likely to attend, even if at the expense of the preferences, priorities, conveniences, or even the availability of non-mandatory users.

In a further embodiment, one or more invitees may be mandatorily excluded from the meeting. This unique feature allows the scheduling of events to which a particular user is specifically required not to attend. By way of example and not limitation, a Realtor® seeking to schedule a house showing for a client may use the system to schedule the showing by inviting the client to it, but indicating that the client must not attend, and indicating the home as the venue. Using the systems and methods described herein, the decision engine can examine the availability data for the house (as a venue model) and the homeowner (as a user model) and schedule the showing at a convenient time for the homeowner to vacate the home. In this exemplary embodiment, the homeowner's schedule drives the decision engine, and it is the homeowner whose availability (or lack thereof) is used to make the decision when to schedule the showing.

These embodiments may be further modified to schedule the candidate meeting for which the largest number of users accepted and the inviting user (103A) accepted. By way of example and not limitation, where a plurality of candidate meetings are offered and the largest number of users (103) select the first candidate meeting, but the inviting user (103A) declines the first candidate meeting and accepts the second candidate meeting, the second candidate meeting may be scheduled even though more users (103) accepted the first candidate meeting. In a still further embodiment, the inviting user (103) may specify, when initiating the scheduling process, whether inviting user's (103A) presence is required.

In a still further embodiment, users (103) may both accept a plurality of candidate meetings and indicate a most preferred candidate meeting. Optionally, users (103) may further indicate a second, third, etc. most preferred candidate meeting. The decision engine (113) may then schedule the meeting based not only on availability data, but also on the indicated user preferences with respect to the proposed candidate meetings.

After sufficient user (103) responses are received to schedule the meeting, according to the business rules and options selected by the inviting user (103A), the meeting is scheduled on each user's (103) calendar (105) and a notification is sent. Again, the scheduling on the individual calendars (105) is generally done using an API, as it is presumed in this use case that each user (103) is registered to use the scheduling system and has shared the user's (103) respective calendar (105) with the decision engine (113).

Another aspect is that events may be scheduled based upon a condition, contingency, dependency, or prerequisite. For example, a drywall company cannot be scheduled in a home construction project until the roof and windows are installed. In such an embodiment, the completion of a previously scheduled task (i.e., window installation) could be a prerequisite provided to the decision engine, which would not schedule the drywall installation until the window and roof installation is completed. This may be implemented, for example, using pools (described below) or other identifiers or information provided to identify related tasks. By way of example and not limitation, a project, job, or task identifier may be provided in connection with an invitation and used to identify dependencies. Alternatively, this may be implemented by linking a plurality of SDOs (described below), with a dependent SDO not activating or scheduling an event until the independent SDO is marked as completed.

This prevents the system from scheduling appointments that only need to be later removed because they depend on another appointment that may not be completed on time. By way of example and not limitation, in the prior art, a drywall installer may be scheduled on the assumption that roofing and windows will be completed by a certain date. However, the roofing and/or windows may be delayed due to unforeseen factors, such as a labor strike, inclement weather, or delay in material or machinery availability. In the prior art, the drywall contractor would have to be manually rescheduled, which produces inefficiencies, in that the drywall contractor would have already blocked out time for the drywall installation. If the general contractor remembers to reschedule at all, the drywall contractor now has availability in the immediate term, which the contractor may struggle to fill on short notice.

Using the systems and methods described herein, by contrast, the drywall contractor is not scheduled at all until the roof and windows appointments are confirmed or marked as being completed, at which point the connected drywall SDO is automatically scheduled as described herein. Relatedly, such scheduling may also consider the availability of needed tools, equipment, or personnel. By way of example and not limitation, the drywall contractor may require the drywall to first be delivered to the site by a third party. The system would schedule the third party delivery and, upon confirmation of the delivery, schedule the drywall contractor. Another advantage is that unrelated parties can have events scheduled based on each other's availability and/or project completion without knowing each other or having any relationship or communication.

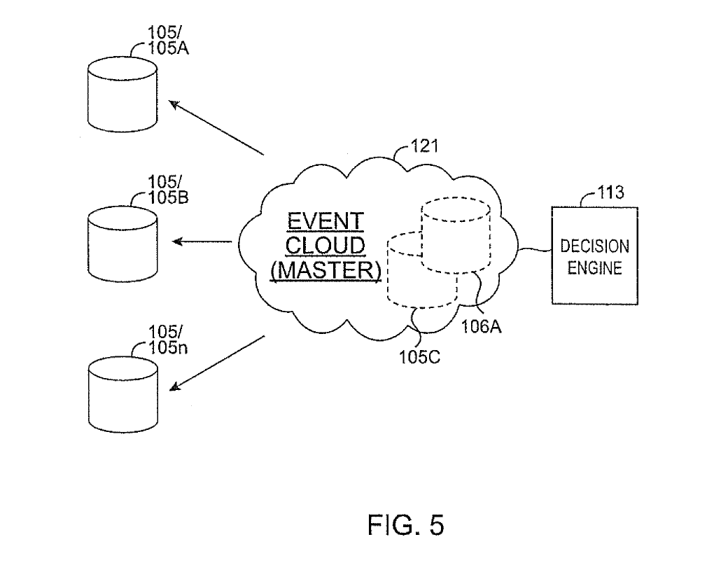

It should be noted that the architecture of the system will generally include an event cloud (121), which is essentially a system of data hierarchies or other data sets which function as a view into each user's calendars. Each user may share or otherwise connect third party calendaring systems, but the event cloud (121) will generally comprise a “master” calendar object for each user, which is the data object accessed by the decision engine to get calendar data for the user. This data object may in turn get data from a third party calendaring system, which may be done in real-time, through caching or other techniques known in the art. FIG. 5 depicts an exemplary embodiment. In FIG. 5, the decision engine (113) is communicatively coupled to the event cloud (121), which in turn is communicatively coupled to calendar data (105) held by third party calendaring systems. For such users, programming logic for the event cloud (121) handles get/push operations between the event cloud and third party calendaring data (105).

For example, a user having associated calendar data (105A) in the custody of a third party calendaring system registers to use the system, and the event cloud (121) creates a master calendar model (106A) for that user. As the user interacts with the system, the master calendar (106A) is updated with the user's schedule and appointments, and may also synchronize with third party calendar data (105A). The degree and extent of this coordination and synchronization will necessarily depend on the features supported by the third party calendaring system (105A). In an alternative embodiment, the master calendar (106A) does not contain separate data, but rather communicates in real-time with third party calendaring data (105A) to service requests from the decision engine (113). In still further embodiments, a user does not maintain a third party calendaring system at all, but rather the calendaring data (105C) is also the master data record. From the perspective of the decision engine (113), however, all scenarios use the same basic application programming interface, hiding implementation details from the decision engine (113) and presenting a uniform interface to the decision engine (113) regardless of what kind of user (i.e. use case) is using the system, and regardless of where and how the event cloud stores or accesses the data. The system can thus operate with or without access to a third party calendaring system, and is not dependent upon a third party calendaring system.

This has many advantages over the prior art. Among them are that no user (103) need have access to any other user's (103) calendar information (105), and that the process of determining a mutually available date is handled automatically in the background without users having to exchange availability. This avoids lengthy back-and-forth negotiations through which users offer up various dates, times and places and negotiate when and where they will meet. Also, as discussed above, parties may schedule events or appointments without even knowing each other.

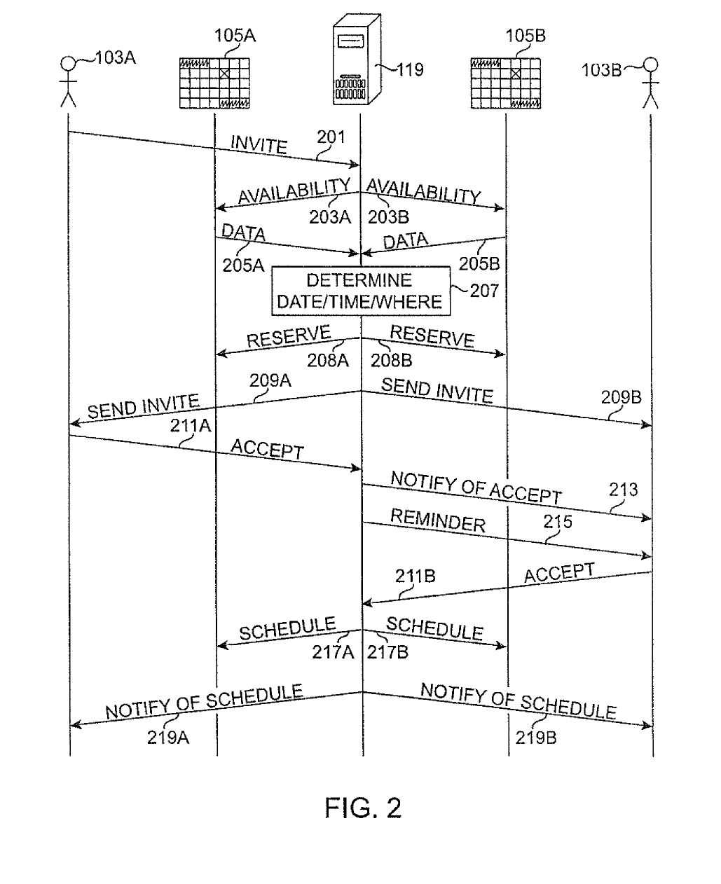

The depicted embodiment of FIG. 2 is a more detailed timeline of a typical, but not limiting, use case involving two users (103A) and (103B) attempting to schedule an appointment. In the depicted embodiment, inviting user (103A) has associated calendar data (105A) and invitee user (103B) has associated calendar data (105B). Although only one invitee user (103B) is shown, the principles, concepts, systems, and methods described with respect to FIG. 2 are generally applicable to use cases comprising a plurality of invitee users (103B) to (103n).

The inviting user (103A) sends an invite (201) to server (119). The invite (201) generally has at least the following data: (1) an indication that inviting user (103A) is attempting to schedule a meeting; (2) an indication of inviting user's (103A) identity, generally some form of inviting user (103A) identification data such as an e-mail address or a unique user ID; (3) an indication of invitee user (103B), also generally some form of invitee user (103B) identification data such as an e-mail address or a unique user ID.

One of ordinary skill in the art will appreciate that the initiation of the invite may be performed through third party software and in connection with third party service platforms. By way of example and not limitation, a software component may be linked to the systems and methods described herein and embedded in a third party service platform, such as a web site, e-mail message, or software application, which component is operable via a user interface element (e.g., clicking on a “Schedule Me” button embedded in a third party web site, or verbally asking a digital assistant via speech-to-text to schedule a meeting with a contract). When the user interfaces with the software component, the user can initiate a scheduling operation with the individual associated with the software component. Also by way of example and not limitation, a user may speak “schedule a meeting with John Doe” into a mobile phone, and the device may integrate with a system implementing the present disclosure to schedule a meeting with “John Doe,” who is one of the user's contacts.

Alternatively, a personal web site may contain a “Schedule Me” button or component which is operable to schedule a meeting with the user associated with the personal web site. This feature in particular may be useful for those whose professions require frequent scheduled meetings with members of the public, ranging from doctors and lawyers to mechanics and stylists. Still further, such a software component may be embedded in a third party marketplace or platform such as a social media platform, liked Facebook or LinkedIn®, enabling browsing users to quickly schedule appointments with the user associated with the software component. Operating the embedded component again will generally trigger the use of the systems and methods described herein, usually through an API, and engage the decision engine to find an appropriate date, time, and/or place for the meeting or appointment according to the present disclosure. This allows activities and encounters initiated outside of the systems and methods of the present disclosure to use the systems and methods of the present disclosure.

It should be noted that inviting user (103A) need not necessarily know the e-mail address or a unique user ID for inviting user (103B). The GUI may simply present a human-readable, user-friendly name for invitee user (103B) and when inviting user (103B) indicates the human-readable name to invitee, the user identification data for that user is looked up in the background by the GUI for transmission to the server, using generally known techniques such as, but not necessarily limited to, performing a lookup in local data or querying a remote host. Alternatively, the human-readable name can be sent to the server, and the server can perform such lookups. These techniques can also be applied to user identification data for inviting user (103A).

The invite (201) generally does not include any indication of when or where inviting user (103A) desires to meet with invitee user (103B). A feature of the system is that the decision engine (113) determines when and/or where to meet. However, in an embodiment, the invite (201) may include a suggested or proposed meeting date/time/place. In one such embodiment, the decision engine (113) will suggest the first candidate meeting at the date/time/place proposed in the invite if all users (103) are available at the suggested time; otherwise, the decision engine (113) will determine a first candidate meeting as described elsewhere herein. In such an embodiment, the suggested date/time/place is itself user behavioral data that may be tracked and considered by the decision engine (113) in scheduling future meetings including inviting user (103A).

The invite (201) may include other information as well, including but not necessarily limited to one or more of: the topic, subject, or purpose of the meeting; a description of the meeting; attachments such as files or documents relevant to the meeting; a calendar identification (e.g., for users with multiple calendars in a given calendaring system); scheduling preference data; scheduling parameters (e.g., a specific date, location, or range of dates during which the meeting should be scheduled); location preference data; required attendee data; and other data known in the art to be used in calendaring and event planning.

The invite may comprise additional data, information, features, or embedded links or software components for other functions of the systems and methods, such as, but not necessarily limited to, chat and messaging features. User interaction with chat and messaging features may be used in connection with building a preference model for each user according to the present disclosure.

In an embodiment, the systems and methods support the addition of attachments or other documents to be associated with an SDO (described elsewhere herein). Such documents or attachments may comprise any logical or physical file, including, without limitation, image documents, graphics, photos, audio recordings, and vCards. One or more of these may in turn be distributed to invitees in connection with the invite.

Upon receipt of the invite (201), the server (119) checks for user availability (203A and 203B) by querying calendar data (105A) and (105B) for each user (103A) and (103B). This query is generally done in the background, without either user (103A) and (103B) being aware of it. A user's (103A) and (103B) calendar data (105A) and (105B) may be stored and/or maintained by the scheduling server (119) or related systems, in which case the server (119) will generally be able to access the calendar data (105A) and (105B) without any special permissions or settings. However, it will be typical that calendar data (105A) and (105B) also will be stored in an unrelated third party calendaring system, such as Microsoft® Exchange® server, or Google® Calendar. In this case, users (103A) and (103B) generally “share” or otherwise arrange for scheduling server (119) to have access to such calendar data (105A) and (105B). A master calendar is formed in the event cloud (121) and generally connected or linked to the third party calendaring system. The scheduling server (119) can then automatically access and perform read/write operations on calendar data (105A) and (105B) without requiring further user interaction, thereby increasing system automation and reducing the burden on users, subject to the technological limits imposed by third party calendaring systems. Again, the master calendar in the event cloud (121) is the definitive source of data for the decision engine (119), though the particular implementation of the data models may vary. For example, a user may not use a third party calendaring system at all, or data from a third party calendaring system may be mirrored, cached, or otherwise duplicated and/or synchronized locally with the master calendar in the event cloud (121). This has the advantage of providing access to calendar data (105A) and (105B) even if third party hosts are unreachable (such as in the case of a network outage or maintenance window), reducing bandwidth usage, and reducing system latency and response time.

It should be noted that user availability is further assessed in consideration of the behavioral and preference model constructed by the systems and methods for each particular user. As described elsewhere in this disclosure, such model includes user preferences, priorities, behavioral data, and system-generated data.

Typically, where third party calendar data is shared, the master record in the event cloud (121) will be populated with the contents of the third party calendar data. This is generally done with one large transfer or “data dump” from the third party calendar, which is supplemented or updated periodically over time. The particular amount and schedule for these operations will vary from embodiment to embodiment. By way of example and not limitation, where a user first connects a new calendar, the last year of data may be imported, with older years added in periodic updates once per day until the master schedule in the event cloud (121) contains all data in the third party calendar.

In an alternative embodiment, the availability query (203A and 203B) may (but need not) include parameters limiting the amount or type of data to be returned (205A and 205B), such as date limitations or ranges of dates. In the typical case, the decision engine (113) needs a relatively small amount of calendar data to make decisions. In some use cases, the inviting user (103A) may desire to schedule the meeting at the earliest possible time, in which case the scheduling server (119) may request only the next two weeks of calendar data (105A) and (105B) for each user. In other use cases, inviting user (103A) may wish to schedule the meeting, but not until some amount of time has passed, in which case the scheduling server (119) may request data for the two weeks immediately following such amount of time. This reduces bandwidth and workload for the scheduling server (119) and third party hosts.

By way of example and not limitation, where the meeting is a follow-up call to discuss action items for a business project, inviting user (103A) may wish to schedule the meeting no sooner than one week from the present time. Alternatively, and also by way of example and not limitation, where the meeting is a birthday party, inviting user (103A) may wish to schedule it during a limited range of time in the future (e.g., the week in which the birthday occurs).

These parameters are an example of additional data that can be provided to the decision engine (113) and/or the scheduling server (119), either in the invite (201), or as described elsewhere herein. Such parameters are generally provided by the inviting user (103A) using the GUI when the invite (201) is first sent. Where no such parameters are provided, default parameters may be used. These defaults may be system defaults, and/or may be learned default preferences for the inviting user (103A). By way of example and not limitation, where inviting user (103A) has exhibited a pattern of declining candidate meetings scheduled within 24 hours of the invite (201), the decision engine (113) may, absent any other parameters, avoid candidate meeting times within 24 hours of the invite (201).

In an embodiment, the system includes software for implementing parameterized invitations. This may be done, for example, using lexical keys, such as the popular “hashtag” use of the pound (#) symbol. In such an embodiment, a user may include a hashtag in the invite, invite description, or an input component dedicated to the parameterization function, which will then be used by the decision engine to refine and limit availability determinations. For example, a hashtag like #biz may cause the search engine to consider only times on Monday-Friday between 8 a.m. and 5 p.m. The system may have predefined or preset parameterization, such as #biz, #family, and #fun. In an embodiment, the system includes software components for users to customize these tags. In a further embodiment, the system includes user-customizable and/or user-defined parameterization. For example, a user who works a third shift IT help desk may keep different “#biz” hours than a day worker. Also by way of example, a user may set up a user-defined tag, such as “#school,” which limits appointments to the user's children's school hours.

Upon receipt of the requested availability data (205A) and (205B), the scheduling server (119) uses the decision engine (113) to determine (207) a date/time and/or place for at least one candidate meeting between users (103A) and (103B). The systems and methods for making this determination are described elsewhere herein. In the depicted embodiment, for each of the candidate meetings, the scheduling server (119) reserves (208A and 208B) the candidate meeting on each users' calendar (105A) and (105B). The technique for making the reservation in the calendars (105A) and (105B) will necessarily vary with the calendaring system. For example, some calendaring systems may include a reservation feature whereby a proposed appointment time is indicated in the calendar (105A) and (105B) as a reservation and not a set meeting. In other systems, each of the candidate meetings must be reserved as an actual appointment (which is later deleted as described herein once a specific date is selected). For such systems, scheduling server (119) may provide some indication the meeting is a reservation only, such as an indication in the meeting title or description.

After reserving (208A) and (208B) the candidate meeting(s), the scheduling server (119) sends a communication (209A) and (209B) to each of the users (103A) and (103B). This communication (209) generally includes information about the proposed meeting, such as any additional information provided by the inviting user (103A). By way of example and not limitation, this information may include the identity of the inviting user (103A), the topic or purpose of the meeting, a description of the meeting, and so forth. The communication may further include the invitee user(s) (103A), depending on factors such as user preferences, the number of invitees, the subject of the meeting, and parameters provided by the inviting user (103A). By way of example and not limitation, inviting user (103A) may indicate that the meeting is an anonymous or private meeting, which causes the schedule server (119) to not include any other invitee user (103B) information in the communication (209). In an alternative embodiment, inviting user (103A) may also be anonymous.

The communication (209) is preferably sent as “push” messaging and may be preferably sent via push messaging to a mobile device, or similar technology, may alternatively be sent via an e-mail message, but may also be sent using any other communications technique now known or in the future developed in the art, including through the use of third party communications platforms. By way of example and not limitation, the communication (209) may be sent via: e-mail; text message; instant message; Facebook® message; Twitter® message; or any other form of electronic communication. Generally, registered users provide a communication preference and the communication (209A) and (209B) is sent using the user's preferred communication channel. In the absence of a set user preference, a default setting may be used, such as the user's e-mail address.

The invitation communications (209A) and (209B) generally include a mechanism or means for each user (103A) and (103B) to indicate his or her desire to accept or decline each of the one or more candidate meetings proposed. For example, where the invitation communication (209) is an e-mail message, the e-mail message may include a clickable link which, if clicked by a user (103), indicates that the user accepts (or declines) a particular candidate meeting. In an embodiment, notification systems embedded in the operating system or in a particular software application may be used. As described elsewhere herein, arbitrary-format file upload may be supported in an embodiment, including the ability to associate and distribute multimedia documents. Alternatively, the e-mail message may include graphical components, such as a rich text or HTML-formatted e-mail which includes GUI elements for accepting or declining each candidate meeting. In a still further embodiment, the e-mail (or other communication (209)) may include a link or other navigation component which directs the user to web site or launches an application which provides an interface for accepting or declining. In a still further embodiment, there is no confirmation step. By way of example and not limitation, a user may configure the system, or the system may otherwise be configured, to automatically accept an invitation on behalf of an invitee if the invitation originates from a particular inviting user and/or pool. Pools are described in detail elsewhere herein. This allows meetings to be scheduled when one or more users are not immediately available to accept or decline the invitation, such as when an invitee is on an airplane, on vacation, or otherwise indisposed. This also may particularly be applicable where the inviting and invitee user have an existing relationship of trust, such as a parent scheduling appointments with or for a child. This may also particularly be applicable for a pool, where the nature of the pool also is based on such a relationship, or otherwise vests the inviting user with such discretion, such as a manager scheduling a mandatory employee.

Although the systems and methods are generally described with respect to a GUI, it is specifically contemplated that a voice-activated or voice-recognition interface may be used to interact with the system, including but not necessarily limited to voice recognition technology on mobile devices such as Siri™. By way of example and not limitation, a user may speak a verbal instruction to schedule a meeting with particular invitees and a client-side software agent or intelligent assistant program arranges and transmits the invite (201) data to begin the scheduling process as described herein. Similarly, responses may be accepted verbally by invitee users using similar techniques.

In one embodiment, the invitation communication (209A) and (209B) may provide only one candidate date, which each user (103) may accept or decline. If any user (103) declines (not depicted), the server (119) may delete the reservation (208) from all calendars (105), the decision engine (113) may select (207) a second candidate meeting, and the server (119) may issue a second invitation communication (209). This cycle may repeat indefinitely with a third candidate meeting, fourth candidate meeting, etc., until an agreeable meeting time is provided. Alternatively, the cycle may repeat only a specific number of times before the server (119) indicates in the communication (119) that no mutually agreeable date can be found consistent with the provided parameters. The inviting user (103A) may then provide less restrictive parameters, or instruct the server (119) to provide a best match even if the best match does not meet all of the parameters.

Each time a candidate meeting is accepted or declined, the user's (103) decision provides actionable behavioral data that can be analyzed, mined, and processed by the decision engine (113) or other software in the system when attempting to schedule future meetings which include the user (103), whether as inviting user (103A) or an invitee (103B). Thus, although the system does not completely avoid the necessity of the back-and-forth where multiple candidate meetings are proposed, more behavioral data is acquired for each user in each round and such data incrementally improves future decisions.

In the depicted embodiment of FIG. 2, inviting user (103A) accepts (211A) the invitation communication (209A). Again, as described elsewhere herein, in an alternative embodiment, the inviting user need not necessarily receive an invite, as the act of initiating the invitation and sending it out to others may be assumed in the business rules of a particular implementation or embodiment as an implicit acceptance by the inviting user, as the inviting user will be generally assumed to select a target date/time from a range of possibilities chosen and offered by the decision engine according to the present disclosure.

However, since the invitee user (103B) has not yet accepted, the scheduling server (119) takes no further action with respect to accepting/inviting user (103A). Scheduling server (119) may send a notification to the invitee user (103B) or, alternatively, all other users (103), such as where the accepting user (103) is one of several invitee users. In the use case of the depicted embodiment, invitee user (103B) fails to respond and, after a predetermined amount of time, the scheduling server (119) sends a reminder communication (215) to invitee user (203B) indicating that the proposed meeting is awaiting the invitee user's (103B) feedback. The predetermined amount of time for such reminders may be determined using a system setting, inviting user (103A) preference, invitee user (103B) user preference, or invite (201) parameter. It is preferred that the reminder communication (215) is generally similar to the invitation communication (213B) so that invitee user (213B) has immediate access to the accept/decline mechanism and does not have to hunt through prior messages for the original communication. This increases the likelihood that invitee user (213B) will accept or decline promptly. After the invitee user (103B) accepts (211B) the candidate meeting, the scheduling server (119) schedules (217A) and (217B) the meeting on each user's (103A) and (103B) respective calendar (105A) and (105B) at the date, time, and/or place proposed in the candidate meeting. If multiple candidate meetings were proposed, the candidate meetings which were not selected, but which were reserved on the calendars (105), are deleted from the calendars (105). The scheduling server (119) then sends a notification communication (219A) and (219B) to each user (103A) and (103B) that the meeting has been accepted and is scheduled. The notification communication (219) also generally contains the details of the scheduled meeting as described elsewhere herein.

The illustrative use case depicted in FIG. 2 presents one possible combination of communications and features used to schedule an event, but it is by no means limiting.

For example, where an invitee user (103B) declines all proposed candidate meetings, the scheduling server (119) may withdraw all reservations on all calendars, send a notification of the declined meeting time to all other users (whether or not they have accepted or declined), and proposed a new candidate meeting. This is because if the declining user is required to attend and declines, a new meeting time must be proposed regardless of whether any other invitees are available.

In an alternative embodiment, the invitees may not receive or otherwise have access to notifications until they respond to the invite, as the date, time, and or place indicated in the invite is dynamic and subject to change. In an embodiment, a user who has not yet responded to the invite may have access only to the candidate most recently accepted by another user.

It should be noted that, limitations and business rules in third party calendaring software may result in variations to the specific order of operations described herein, and in how features are implemented. By way of example and not limitation, certain third party calendaring platforms may not support “reserved” time, or may treat “reserved time” as blocked out. Alternatively, users may simply prefer that the system not reserve any time until the user has accepted the invite to avoid unnecessarily blocking out times when the user is available for purposes of other appointment setting. Thus, in an embodiment, the system may not post a reservation to a third party calendaring system until the associated user has accepted an invite.

It should further be noted that the user need not necessarily know that a reservation has been made. Particularly where the user does not use a third party calendar, the reservation need only be tracked in backend processing. Since there is generally no mechanism for altering a user's scheduling data in the system other than by use of the system, the decision engine may place hidden reservations, internal to the systems and methods described herein, which are not necessarily visible to the user. In a still further embodiment, the user may view and alter such reservations, or configure the system not to set them.

Although in the preferred embodiment, and typical case, the master calendar data comprises sufficient calendar data to schedule events in real-time, there may be cases where the initial data return (205) is not sufficient to schedule a meeting. In such cases, multiple round-trips may be required. This may be because the default settings or parameters returned too narrow a data set and no mutually available times could be found. For example, if one invitee is on a two-week vacation, and only two weeks of calendar data (105) are requested (203), that invitee will not be available at any time during the two-week period reflected in the returned data (205). Alternatively, it may happen, particularly for meetings involving large numbers of invitees, that there simply is no uniformly available date. In these and other circumstances, a second availability query (203A) and (203B) may be made to acquire a second set of calendar data (205A) and (205B), and the decision engine (113) may use such second calendar data (205A) and (205B) to identify a candidate meeting.

In certain embodiments, a plurality of candidate meetings are presented in the invitation communication (209). In a further embodiment, options may be presented to the user in order of match probability (e.g., estimated likelihood that the user, or the group, will agree to the proposed time). Each user may select zero, one or more candidate meetings for which the user is available. This has the advantage of increasing the amount of candidate meetings the user is able to attend, increasing the likelihood that the decision engine (119) will identify a mutually agreeable time for the meeting, and providing the user with information about how the system understands the user's calendar and preferences. For example, the system may propose a time when the calendar data indicates a user is available but the user knows he is not available. This may cause the user to revisit his calendar data and schedule additional appointments that were previously overlooked or omitted. Additionally, each of the user's selections provides additional behavioral data to the decision engine, as discussed elsewhere herein. For example, where three candidate meetings are proposed, two of which are in the morning and one of which is in the afternoon, and an invitee user (103B) accepts the afternoon appointment only, at least three pieces of behavioral data are available to the decision engine with respect to that user for future scheduling as a consequence of this one proposed meeting: that the user twice selected not to meet in the morning, and that the user once selected to meet in the afternoon instead. This may indicate to the scheduling engine that the user prefers afternoon meetings to morning meetings, for example.

In a still further embodiment, a user presented with a plurality of potential meeting times can indicate a most preferred time, as well as one or more less preferred but still available times. This has the advantage of giving the decision engine information about user preferences and/or priorities while still allowing the decision engine to schedule the meeting at a time when all are available, even if the availability time is less convenient for some than others. In a still further embodiment, the user may rank or order the candidate meetings, thus providing relative preference data. In a still further embodiment, a user may indicate a refusal to meet at all regardless of when the candidate meeting takes place. In a still further embodiment, user priorities may be used to schedule or suggest a meeting time even if it conflicts with another, lower-priority meeting.

The systems and methods described herein are generally implemented using computer software in a typical client/server architecture, with delivery through a software-as-a-service model. User data is generally stored and access using cloud computing principles. Generally a scheduling server (119) accepts and processes requests received over a communications network (107) from users (103) on client devices (109) such as, but not limited to, mobile phones (109A) or smart phones (109A), desktop computers (109B) and/or laptop and tablet computers (109C). The server (119) generally includes or has access to a storage medium, which is used to store the data used and processed by the system and methods (e.g., the event cloud (121)). Alternatively, the event cloud may be hosted or stored in a third party storage system and access provided or made available to the server (119). This data includes, without limitation: user account and profile data, user preference and priority data, calendar data, user behavioral data, group/pool data, venue data, view data, event data, SDOs (described below), master schedules, alert data, and user decision history. Typically, this data is stored in a structured and easily accessible manner, such as a database, which may comprise an SQL database, a no-SQL database, a graph database, or any other appropriate data structure now known or in the future developed in the art.

This disclosure generally describes that the decision engine (113) determines the dates of candidate meetings to propose to invitee users. This is a complex and layered process which may consider a wide variety of factors and data inputs, some of which are described herein. At the most basic level, the decision engine (113) considers the availability of each user as set forth in calendar (105) data. As described elsewhere herein, calendar (105) data may be maintained in third party platforms such as Microsoft® Exchange®/Outlook® and Google® Calendar. This data may additionally, or alternatively, be mirrored and/or synchronized in local copies. Alternatively, calendar data (105) may be stored in a database associated with the decision engine, such as the Skejul™ system. In all cases, from the user experience perspective, the user need only (at most) share calendar (105) data with Skejul, and all other operations are handled server-side (i.e. in the “cloud”). As described elsewhere herein, a master calendar record for each user is maintained in the event cloud (121) and may synchronize with a third party calendaring system. As described below, the implementation effectively creates an interface, or single “view,” into each user's schedule, which can be easily used for data mining, analytics, and predictive computing.

Users may also search their appointments, past and future. Because the data models are updated and connections maintained with respect to an SDO, the event cloud as a single definitive view of the data provides the user with continued access to the changing data. This may be best understood through the use of an example. The system is used to schedule a graduation ceremony for a class of graduating high school seniors at a school. The class may be defined as a pool in the system manually, or the pool may be inferred by the decision engine (119) using other factors, such as but not limited to similar e-mail addresses, similar third party data (e.g., Facebook data showing the users all “Like” the Facebook page for their school), similar behavior (e.g., high acceptance rate to the graduation party), the event description (“Class of '14 graduation ceremony”, e.g.,) or the venue (“East High Auditorium,” e.g.). Five years later, many students have gone their separate ways and changed contact information, and some have gotten married and changed names. However, each user has a user model in the event cloud (121) and to the extent any of the users have used the system and/or kept their user data updated (e.g., contact information), those users can still be reached. Thus, when the five year class reunion is ready to be scheduled, the planners can splash message all of the users in the pool to immediately get in touch with the class members, even if some have changed names, locations, or contact information.

The decision engine (113) may also consider user-defined preferences and priorities, which are generally defined and provided by the user using the GUI, as well as inferred preferences and priorities derived from data analysis and data mining. User preferences may indicate particular dates, times, and/or places, or a combination thereof, when the user does (or does not) wish to meet. By way of example and not limitation, a user may prefer not to meet after 3:00 p.m. on Friday, or prior to noon on Mondays. Preferences are not limited to times, as a user may indicate in preferences that the user prefers to meet in a specific geographic region during the work day (e.g., near the user's place of work), and in another geographic region during evenings and weekends (e.g., near the user's residence). These preferences are generally provided, and are not displayed or made available to other users. This enables the decision engine (113) to consider such preferences when scheduling meetings with the user, but without sharing to other users the reasons why the user is not available at certain times or places. This protects the user's privacy, respects the user's preferences, and improves the likelihood that meetings will be scheduled at times and places when the user is available.

The decision engine (113) may also consider learned preferences based on observed user behavior. Such user behavior may comprise user responses to prior attempts to schedule meetings using the systems and methods. As described elsewhere herein, each time a user is presented with a candidate meeting and accepts or declines (or even ignores) a given meeting, the user's choice provides behavioral data which can be recorded in data storage (115) and later analyzed, such as to identify patterns or other data features indicative of a user preference. Such patterns may be as simple as a user routinely making the same decision when faced with a given candidate meeting (e.g., the user has rejected all candidate meetings proposed before 10:00 a.m. on a weekday) or more complex analysis requiring the use of sophisticated predictive computing and data mining algorithms.

In an embodiment, this aspect of the present disclosure may be applied to promotional events and activities, such as, without limitation, musical performances at local venues, and festivals. In such an embodiment, the decision engine may calculate a predicted relevance of a given event, activity, or content based on the user models, and present to the user only those events determined to have a high likelihood of relevant, reducing unwanted noise in marketing communications. By way of example and not limitation, if the user's calendaring data indicates that the user has a meeting scheduled in Chicago on a given day, the system will not present marketing information related to an upcoming Cardinals baseball game in St. Louis.

User behavior may additionally or alternatively comprise messaging communication with other users via chat and messaging features associated with the system. By way of example and not limitation, user intent and preferences may be inferred, predicted, or otherwise determined using natural language processing of such messaging.

Some such algorithms and techniques are known in the art, and may include, without limitation: “hill-climbing” iterative improvement algorithms; approximate modeling and/or reasoning; association learning; back propagation; backtracking; Bayesian networks; confusion matrices; decision modeling; decision trees; diffusion maps; fuzzy functions; Gaussian; genetic algorithms; evolving algorithms; halving algorithms; heuristic guidance; hidden Markov models (HMMs); hierarchical generative models; inducer/induction algorithms; kernel methods; learning automata and transducers; machine learning; Markov decision processes (MDPs); neural net learning algorithms; neuro-fuzzy techniques; perceptron algorithms; ranking algorithms; reflexive functions; regression algorithms; reinforcement learning; resubstitution learning; feedback loops; supervised learning; support vector machines (SVMs); unsupervised learning; weighted majority algorithms; and other algorithms and techniques known or in the future developed in the art.

In effect, the decision engine (113) functions as an intelligent software assistant, sometimes called an intelligent software agent, cognitive assistant or cognitive agent in the art. The engine learns, organizes, and correlates data, combining traditionally isolated data mining approaches with artificial intelligence to create a personal-assistant program that improves its predictive accuracy by interacting with its user. Similarly, from a user experience, the client-side software used by the user to interact with the decision engine (113) is generally engineered to behave like an intelligence software assistant, including features such as a voice and plain language interface.

This type of processing requires careful mapping of data relationships. The event cloud (121) generally reflects the principle that there should be one authoritative and definitive source of data from the perspective of the decision engine, which queries the event engine to acquire all data needed to make decisions. This principle is generally implemented through a specialized data structure referred to herein as a Skejul Dynamic Object (“SDO”). In the most general terms, an SDO is a software object that roughly corresponds to an attempt to schedule a meeting or event. While the precise content of an SDO will necessarily vary from implementation to implementation, generally speaking, an SDO comprises, includes, incorporates, references, points to, or links to user models, venue models, and, in some cases, pool models. These models are described in detail elsewhere herein. When a user (103A) attempts to schedule an event, an SDO is created in memory corresponding to the event. There is typically one and only one SDO per attempted event. Typically, the user (103A), represented in memory by a user data record or user profile (303A), attempts to schedule the event and supplies or makes available, at a minimum, an identification of the user attempting to schedule the event. Typically, the user (103A) is logged in or otherwise connected to the Skejul system, such as through a website, mobile device application, desktop application, standalone application, or other software, including but not necessarily limited to a software plugin for an existing calendar application.

The user model may be formed based upon other data as well, such as other platforms publicly available or shared with the system. These include, but are not limited to, Facebook®, Linkedin®, Twitter®, and other social networking platforms, or behavioral data, such as services offered or provided by Traitify™.

When the user manipulates the graphical user interface to begin scheduling an event, the user ID associated with the inviting user is transmitted or caused to be transmitted to the Skejul server, generally using the communications network as described elsewhere herein. The Skejul server then forms or causes to be formed a new SDO (301) in memory, and associates (302) the user model (303A) for the inviting user (103A) with the SDO (301). Thus, at the outset, the SDO (301) comprises, at a minimum, a software view into the user model (303A) for the inviting user (103A). In the typical case, the inviting user (103A) will also specify one or more other users (103B) to (103n) with whom the inviting user (103A) wishes to schedule the event. The inviting user (103A) may manipulate the interface to indicate the identification of the invitee user or users (103B . . . 103n), and those indications are also generally transmitted to the scheduling server (119) over the communications network (107).

The scheduling server (107), upon receiving the indication of the invitee user or users (103B) to (103n) may do one or more of a number of different steps. In a typical case, upon receipt of the data, the server (119) will associate (302B) to (302n) the user models (303B) to (303n) for the invitee user to the newly created SDO (301). The identification of the invitee (103B) to (103n) and inviting user (103A) is typically an e-mail address or other unique identifier. If the user is already registered to use the system (e.g., the Skejul™ system), then a unique Skejul™ user ID may be used instead. Where the inviting user (103A) is logged in to the system, the Skejul™ ID is known and will be used to associate (302A) the user model (303A) in Skejul with SDO (301).

Where the invitee user (303C) is not already a registered user, a different identifier may be used or, alternatively, a provisional identifier may be assigned. For example, where a registered user invites (201) an invitee user (303C) who is not registered, the registered user typically does so by providing a known identifier for the invitee user (303C), such as the invitee user's (303C) e-mail address. When the scheduling server (119) encounters the e-mail address in the invite (201) data, the server (119) generally will search the data (115) for a user profile (303C) associated with that e-mail address. If no such profile exists, the server (119) will create it and assign it a system user ID, as well as provide the supplied e-mail address for the invitee (303C) as the default communication preference and address for the user. The newly created user profile (303C) can then be associated (302C) with the newly created SDO (301). Thus, although the user (303C) is not registered, the user can essentially be treated in data the same as registered users. This has the advantage of providing a uniform data structure, reducing code complexity and development time. Also, when this e-mail address (or other user identifier as the case may be) is encountered in future scheduling invites (201), even invites (201) completely unrelated to the initial scheduling invite (201), the user record (303C) can be used to track, store, and mine behavioral data in association with the user. Thus, invitees who are not actually registered users nevertheless benefit from the system because data can be gathered about the user's preferences through indirect observation (i.e., as various registered users invite the unregistered invitee to events and the invitee accepts and declines meetings), and behavioral data may be tracked and mined, just as for registered users.

Once each user model (303) is linked to the SDO (301) the decision engine may begin to determine a date/time/place for the meeting as described above. For users with more calendar and preference data, the system will generally be able to provide better optimized candidate meetings. For users who have not shared calendar data, the system may have reduced ability to provide accurate predictions for such user's availability. This typically will be the case for unregistered users, unless public calendar information is available for such users. Thus, the decision engine may propose times when that user is not available, even though the user has indicated in his calendar data that he is not available, because the server (119) cannot access that data. Brand new users may be effectively a near blank slate because no calendar data is accessible and no behavioral history has yet been developed. However, as other users invite such new users using the system, the amount of data on the new user's preferences will expand and result in incrementally better optimized and more meaningful predictive analysis for that user, even if the user does not register with the system. Similar techniques are used to create venue profiles (305) and associate (304) them with an SDO (301), and to create pool profiles (307) (described below) and associate (306) them with an SDO (301).

While in a typical case a single data point for a user may not be significant, the SDO can be used to derive meaning and context from a single data point. This may be done through the use of pools. Although the indication by a single user that he is declining an invitation is by itself not meaningful, a larger number of indications by invitee users that they are declining the same meeting may provide meaningful context for an individual user's decision. This may be best understood through use of an illustrative example.

Suppose that the coach of a junior high school football team invites the parents of all of the children on the team to a meeting on a Friday evening in the fall, and a significant number of invitees decline because they have other children participating in the local high school football game that evening. First, an SDO (301) is created for the proposed meeting, and a large number of invitees (303B) to (303n) are not registered users, so new user models (303) are created for each of them and associated (302) with the SDO (301). The decision to decline, for each declining user, is recorded in data storage (115) in connection with the user profile (303).

The decision engine (113) can observe that a significant number of invitees declined by using the SDO as view into the collective decision making of the pool. That is, when a different and unrelated inviting user later uses the system to invite (201) a group of invitee users (303B) to (303n) which substantially overlaps with the invitee list to the football meeting, the system detects the overlap by looking at the list of user profiles (303) linked (302) to the SDO (301) and examining the decisions made by each user in response to the invite. Identifying that the users associated with the SDO (301) previously declined a Friday night in the fall en masse, the decision engine (113) predicts that another Friday night meeting in the fall is also likely to be declined en masse by these users. The decision engine (113) can then avoid Friday nights in the fall and suggest alternative times, which the users are more likely to accept. Thus, although the system has only one data point for each of the users (many of whom aren't registered with the system at all), the users' appearance in the pool, and the pool's collective behavior, provides useful analytics which can be used to improve predictive optimization for future invites including those users, even if such subsequent invites do not include the other members of the pool.

This aspect may be applied in an embodiment to suggested or promoted events or activities, in that a pool affiliation may imply that a particular event may be highly relevant to a particular user. By way of example and not limitation, where a user is invited to a craft beer testing event, the decision engine may determine that such a user is likely to be interested in an upcoming Oktoberfest event for which the user is available, and may provide a notification to the user of the event in the form of an invite, which the user may accept to place the event on the user's calendar. The invite may further comprise instructions or other components for acquiring tickets to the event.

In a further embodiment, the decision engine may impact search results, or the presentation of search results. By way of example and not limitation, discovery of new activities can be influenced by what a user is already scheduled to do, or where a user is already scheduled to be. For example, if the user searches the event cloud for a particular type of event, such as “Cardinals baseball,” the search results may only show upcoming events which do not conflict with the user's schedule, or may show such results but indicate that there is a conflict, and what the conflict is. Alternatively, the search results may omit events which the user has a high probability of not being able to attend due to a high priority behavioral factor. For example, if the user never schedules downtown non-business events after 5:00 p.m., the search results may only display daytime and weekend games at a stadium located downtown.

The system can also examine content or other information pertaining to the meeting to derive additional context that may be associated with the individual users who were invitees to the meeting to predict other helpful times, or provide additional context or data for the predicted algorithms. For example, if the meeting invite provides a description of the event, such as a location (e.g., a conference room at the junior high school) or a description of the group or event (e.g., “East Junior High Mustangs football team parents meeting”), this information may be used, optionally in conjunction with publicly available data, to enhance, refine, or otherwise improve the predictive accuracy of the decision engine. In this case, the football schedule for the East Junior High School Mustang football team may be published on a public website and the system can utilize search engine technology to identify, locate, analyze, and incorporate that schedule into its analysis.

While a generic description like “East Junior High” may not appear helpful, and may produce a number of different schedules for different teams, the invitation in this illustrative example included a location, which can be used to identify the specific junior high school, and thus the specific team whose schedule applies. When an unrelated inviting user attempts to schedule a meeting with an invitee to the declined parents' meeting, the decision engine has available to it data indicative that the invitee is likely to be unavailable not only on Friday nights in the fall, but on any date or time when the East Junior High School football team has a scheduled event, as indicated in the publicly available schedule. Thus, a single invite to a large group of users, combined with the pooled behavior of those users in response to that invite and publicly available data, can provide a wealth of actionable data for use in unrelated invitations sent to those same users individually for unrelated matters. Moreover, all of this can be done without the invitee registering with the system and/or sharing any calendar data, though doing so is likely to improve the performance of the system. The simple act of declining the invitation provided the system with behavioral data that, in the context of a pool, provides much more predictive value than the single data point of a declining user standing alone.

The system may also develop implied pools of users based on these types of associations. In the above example, as the system encounters the same basic set of e-mail addresses continually invited to events (even if by different inviting users), the data mining algorithms may determine or identify that the users share a relationship or characteristic with one another. A pool model (307) may be created which is linked to one or more SDOs (301) as well as a plurality of user models (303) (one model (303) for each user in the pool), and the pool model (307) may be further assigned behavioral characteristics and/or vectors that represent the aggregated decision making of the group, independently of individual behavioral data for the individual users (303).

Such vectors may include a “direction” which, in this context, generally means a behavioral inclination or pattern, as well as a “magnitude” which generally corresponds to the predictive value or weight of the behavior represented by the vector. Continuing the prior example, if 80% of the invitees decline, the system may assign a high magnitude to that behavioral vector (i.e., unavailable on Friday evenings in the fall). By contrast, consider a similar illustrative example where the same group of invitees are invited to a fundraising event for the team before the season starts, such as a Tuesday evening in August. Only a small percentage of the invitees declined, each for unrelated reasons, such as a previously scheduled vacation, a work meeting, or a sick child. The low number of declining invitees suggests there is little predictive value to the decline, and the high number of acceptances, by contrast, suggests that there is higher predictive value to the acceptance. Thus, the system is more likely, when the same users (individually or as a group) are invited to an event, to suggest a Tuesday night in summer as a possible meeting date.

Pools may be formed based on a variety of factors, and may be user-defined. In the above example, the pool was formed based at least in part upon the users' collective appearance as invitees, but other factors may be used as well, or alternatively. By way of example and not limitation, a pool may be formed based on domain name, user location at a point in time, a common behavioral response, a user preference, or other data. For example, a marketing firm may form a pool defined as all users located at Busch Stadium in St. Louis, Mo. during a baseball game.

Pools may also be used to deliver “splash” messaging. Splash messaging is essentially a user-defined message or communication sent to all members of a pool, but has the advantage that the sending user need not know the communication preferences or addresses for each user in the pool. Indeed, in certain embodiments, the sending user may not be aware of all of the users, or even how many users, are in the pool. In the above example of a football game at a particular stadium, a splash message may be sent to such users offering a coupon or discount for concessions or memorabilia. For users with the appropriate preferences and permissions set (e.g., the user is willing to receive splash messaging), the splash message is delivered to the user in accordance with the user's communication preferences for splash messages. Certain users may desire to receive e-mails, others may prefer text messages, or in-system or in-application messaging, and so forth. In an embodiment, users may configure the system to automatically accept invitations from specific users or pools.

Similarly, splash messaging exemplifies the benefits of the event cloud as a single source of data, in that changes to the event are updated in the SDO and, since all invitees are connected to the SDO, the changes appear in real-time to each user. By way of example and not limitation, where an event planner or participant needs to share information with the pool, this can be done through the system, and all invitees will receive the messaging whether or not the user providing the updated information knows all invitees or has contact information for all of them. For example, when a coach has a high school track meet scheduled in the system, the runners and parents are typically part of the pool or are following the pool using the social networking features described herein. A last-minute change delaying the start time by 15 minutes and switching the visiting team to a different room is recorded in the SDO for the event, and those changes automatically appear in each of the invitees' schedules. Further, a user (such as the meet planner or a coach) can splash the pool with the message that the start time has been delayed or the locker room has been changed, or the system may provide a generic message stating that the event information has changed, and this can be relayed to individual users via, preferably, push notification or push messaging, and/or a text or e-mail or other notification communication.

Another aspect of the systems and methods is the incorporation of social networking features into a comprehensive social networking platform. By way of example and not limitation, users can “follow” one another and/or share some or all of their activities with one another. The SDO allows event sharing on a more granular level, eliminating the need for users to maintain a plurality of calendars so that different sets of data can be shared with different people according to the user's sharing and privacy preferences, though in an embodiment, users may also group events using various techniques, such as tags. A user's social network may also be automatically populated in an environment based on previously known connections.

The systems and methods described here may also be used in automated fashion by devices, venues, or other non-human users. This type of implementation is sometimes colloquially referred to as the “Internet of things.” Generally speaking, such an implementation comprises the use of one or more sensors or other detection means to identify an actionable problem with a particular resource and indicate to the scheduling server (119) that the resource is unavailable for future scheduling, while also scheduling (using the decision engine) an appropriate meeting for mitigation of the problem. An illustrative example may make this use case clear. Suppose a smoke detector in a hotel room malfunctions, rendering the room legally unusable until the detector is repaired. If the smoke detector is a part of the “Internet of things” (e.g., it has some level of network connectivity, whether through a network cable, wireless communications, the electrical power supply cable, or other means known in the art), the detector's malfunctioning state can be programmatically detected, locally or even by the scheduling server (119), and the specific hotel room associated with the malfunctioning smoke detector has its venue profile data altered to indicate that the resource is unavailable for scheduling.

Thus, when future events are attempted to be scheduled at the hotel (e.g., such as guest booking a room), the server (119) will have access to data indicating that this specific room is not available, and even the hotel staff may be as of yet unaware that the malfunctioning has even taken place. In a further embodiment, the scheduling server (119) can automatically schedule a repair appointment with a registered repair vendor by proposing a repair time with said vendor using the systems and methods described elsewhere herein. Again, this can all be done without the intervention of human users. When the vendor completes repair and the system detects that the smoke detector is no longer malfunctioning, the server (119) can then alter the venue profile for the room to indicate that it is now available for booking.

Although the systems and methods are generally described with respect to scheduling future events, it is specifically contemplated that events may be scheduled using the systems and methods as they are taking place, or where such events are in the past. In the latter case, by providing data concerning prior events, such as but not limited to the invitees, attendees, location, and/or day and time of the event, a larger body of data is made available for the predictive modeling described herein. Also, events may be scheduled in real-time as the event is taking place. This allows the system to capture data about spontaneous gatherings, and also to provide live updates and scheduling information for events, particularly lengthy events such as (but not limited to) conferences. This also facilitates the social networking platform elements described elsewhere herein. By way of example and not limitation, where an event is moved, rescheduled, postponed, and/or cancelled, updated information can be provided and a splash message used to provide real-time updates to the pool of users attending the event. This feature not only provides real-time updates for on-going events but for events scheduled for the future, can be used to provide attendees/invitees with key updates in advance.

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A method for privately scheduling a meeting between two users at a mutually available time without the use of a human intermediary and without specifying a candidate time for such meeting, the method comprising:
providing a scheduling server communicating over a network with an inviting user calendar system and an invitee user calendar system;
said scheduling server receiving an invitation to a meeting between an inviting user and an invitee user, wherein said invitation does not include a candidate time for said meeting;
said scheduling server transmitting to said inviting user calendar system a request for calendar data for said inviting user;
said scheduling server transmitting to said invitee user calendar system a request for calendar data for said invitee user;
said scheduling server receiving from said inviting user calendar system calendar data for said inviting user;
said scheduling server receiving from said invitee user calendar system calendar data for said invitee user;
said scheduling server selecting said candidate time for said meeting as a time said inviting user is available for said meeting as indicated in said received inviting user calendar data, and as a time said invitee user is available for said meeting as indicated in said received invitee user calendar data;
said scheduling server causing to be scheduled in said inviting user calendar system a meeting between said invitee user and said inviting user at said candidate time; and
said scheduling server causing to be scheduled in said invitee user calendar system a meeting between said invitee user and said inviting user at said candidate time.

2. The method of claim 1, where said candidate time comprises a date and time of day.

3. The method of claim 1, wherein:
in said selecting, said scheduling server chooses a plurality of candidate times for said meeting, each candidate time in said plurality of candidate times being chosen because said inviting user is available for said meeting as indicated in said received inviting user calendar data, and said invitee user is available for said meeting as indicated in said received invitee user calendar data at said candidate time; and
wherein, in said causing to be scheduled in said invitee user calendar system;
said scheduling server transmits to said invitee user an invitation to said meeting, said transmitted invitation including each candidate time in said plurality of candidate times;
said scheduling server receives from said invitee user an acceptance of said transmitted invitation, said received acceptance indicating a candidate time in said plurality of transmitted candidate times accepted by said invitee user;

4. The method of claim 3, wherein:
said received acceptance further indicates a preferred accepted candidate time and a non-preferred accepted candidate time;
said scheduling server causing to be scheduled in said inviting user calendar system a meeting between said invitee user and said inviting user at said preferred accepted candidate time; and
said scheduling server causing to be scheduled in said invitee user calendar system a meeting between said invitee user and said inviting user at said preferred candidate time.

5. The method of claim 4, wherein at least one of said candidate times is selected based in part on, in a prior use of said method in which said inviting user was an invitee user, which candidate time in said prior use of said method said inviting user accepted.

6. The method of claim 4, wherein at least one of said candidate times is selected based in part on, in a prior use of said method in which said inviting user was an invitee user, which candidate time in said prior use of said method said inviting user accepted as a preferred accepted candidate time.

7. The method of claim 4, wherein at least one of said candidate times is selected based in part on, in a prior use of said method in which said inviting user was an invitee user, which candidate time in said prior use of said method said inviting user accepted as a non-preferred accepted candidate time.

8. The method of claim 1, further comprising:
said selecting step further comprising selecting a meeting location, said meeting location being selected based in part upon the proximity of other appointments to said meeting location for said inviting user in said inviting user calendar data, and based at least in part upon the proximity of other appointments to said meeting location for said invitee user in said invitee user calendar data;
said scheduling server causing to be scheduled in said inviting user calendar system a meeting between said invitee user and said inviting user at said selected location; and
said scheduling server causing to be scheduled in said invitee user calendar system a meeting between said invitee user and said inviting user at said selected location.

9. The method of claim 8, wherein said location and said candidate time are selected in part by calculating an estimated amount of time for said inviting user to travel to said location from the location of an appointment indicated in said inviting user calendar data as occurring prior to said candidate time.

10. The method of claim 9, wherein said location and said candidate time are selected in part by calculating an estimated amount of time for said inviting user to travel from said location to the location of an appointment indicated in said inviting user calendar data as occurring subsequent to said candidate time.

11. The method of claim 1, wherein said scheduling server receives said invitation from a user device of said inviting user.

12. The method of claim 11, wherein said user device is selected from a group consisting of a mobile phone, a smart phone, a desktop computer, a laptop computer, a tablet computer, and a wearable computer.

13. The method of claim 1, wherein said inviting user calendar system and said invitee user calendar system do not directly communicate with each other over said network.

14. A method for scheduling a meeting between two users at a mutually available time based upon the availability of a group associated with at least one such user comprising:
providing a scheduling server communicating over a network with an inviting user calendar system and an invitee user calendar system;
said scheduling server receiving a first invitation to a first meeting between a first inviting user and a plurality of invitee users, each of said invitee users having calendar data;
said scheduling server associating said first inviting user and each invitee user in said plurality of invitee users in a user pool;
said scheduling server receiving a second invitation to a second meeting between a second inviting user and a second invitee user, said second invitee user being a user associated in said user pool in said associating step;
said scheduling server selecting a candidate time for said second meeting as a time each user in said user pool is available for said second meeting as indicated in said calendar data for said each user;
said scheduling server scheduling said second meeting at said candidate time in said calendar data for said second invitee user.

15. The method of claim 14, further comprising:
providing user pool calendar data comprising a plurality of scheduled events;
said scheduling server associating said user pool with said calendar data;
wherein said candidate time is selected as a time indicated in said user pool calendar data as having none of said plurality of scheduled events scheduled.

16. The method of claim 14, wherein said second inviting user is not a user in said user pool.

17. A non-transitory computer-readable medium for privately scheduling a meeting between two users at a mutually available time without the use of a human intermediary and without specifying a candidate time for such meeting protecting, said medium comprising:
computer-readable instructions for receiving an invitation to a meeting between an inviting user and an invitee user, wherein said invitation does not include a candidate time for said meeting;
computer-readable instructions for transmitting to said inviting user calendar system a request for calendar data for said inviting user;
computer-readable instructions for transmitting to said invitee user calendar system a request for calendar data for said invitee user;
computer-readable instructions for receiving from said inviting user calendar system calendar data for said inviting user;
computer-readable instructions for receiving from said invitee user calendar system calendar data for said invitee user;
computer-readable instructions for selecting said candidate time for said meeting as a time said inviting user is available for said meeting as indicated in said received inviting user calendar data, and as a time said invitee user is available for said meeting as indicated in said received invitee user calendar data;
computer-readable instructions for causing to be scheduled in said inviting user calendar system a meeting between said invitee user and said inviting user at said candidate time; and
computer-readable instructions for causing to be scheduled in said invitee user calendar system a meeting between said invitee user and said inviting user at said candidate time.

18. The medium of claim 17, where said candidate time comprises a date and time of day.

19. The medium of claim 17, further comprising:
computer-readable instructions for selecting a plurality of candidate times for said meeting, each candidate time in said plurality of candidate times being selected as a time said inviting user is available for said meeting as indicated in said received inviting user calendar data, and as a time said invitee user is available for said meeting as indicated in said received invitee user calendar data;
computer-readable instructions for transmitting to said invitee user an invitation to said meeting, said transmitted invitation including each candidate time in said plurality of candidate times;
computer-readable instructions for receiving from said invitee user an acceptance of said transmitted invitation, said received acceptance indicating a candidate time in said plurality of transmitted candidate times accepted by said invitee user;
computer-readable instructions for causing to be scheduled in said inviting user calendar system a meeting between said invitee user and said inviting user at said accepted candidate time; and
computer-readable instructions for causing to be scheduled in said invitee user calendar system a meeting between said invitee user and said inviting user at said accepted candidate time.

20. The medium of claim 19, wherein said received acceptance further indicates at a preferred accepted candidate time and a non-preferred accepted candidate time in; and
said medium further comprises:
computer-readable instructions for causing to be scheduled in said inviting user calendar system a meeting between said invitee user and said inviting user at said preferred accepted candidate time; and
computer-readable instructions for causing to be scheduled in said invitee user calendar system a meeting between said invitee user and said inviting user at said preferred candidate time.
